(19) United States
(12) Patent Application Publication
(10) Pub. No.: US 2021/0324192 A1
(43) Pub. Date: Oct. 21, 2021

(54) Mixed aqueous dispersion of polyimide-fluororesin-polar crystal particulates and a method of producing the same

(71) Applicant: JAPAN MATEX CO., LTD., Osaka (JP)

(72) Inventors: Katsuro Tsukamoto, Osaka (JP); Hiroaki Tsukamoto, Osaka (JP)

(73) Assignee: JAPAN MATEX CO., LTD., Osaka (JP)

(21) Appl. No.: 17/130,597

(22) Filed: Dec. 22, 2020

(30) Foreign Application Priority Data
Apr. 15, 2020 (JP) 2020-073144

(51) Int. Cl. C08L 79/08; C08K 3/34; B05D 3/02; B05D 7/14; C08L 27/18

(52) U.S. Cl. CPC C08L 79/08; C08K 3/34; B05D 3/0254; B05D 7/14; B05D 2505/50; C08K 2201/003; C08L 2201/54; B05D 2506/15; C08L 27/18

(57) ABSTRACT

Provided are a mixed water-based dispersion of polyimide-fluororesin-polar crystal particulates with excellent handleability (e.g. safety, environmental burden, equipment cost) as well as excellent adhesion performance and heat resistance performance without the use of an organic solvent, and a method of producing the same, and a new method of coating. A mixed aqueous dispersion of polyimide-fluororesin-polar crystal particulates according to the present invention comprises a polyimide, fluororesin, polar crystal particulates, and water.

### BACKGROUND OF THE INVENTION

### Field of the Invention

The present invention relates to a mixed aqueous dispersion of polyimide-fluororesin-polar crystal particulates and a method of producing the same, and more particularly to a mixed water-based dispersion of polyimide-fluororesin-polar crystal particulates with excellent handleability (e.g. safety, environmental burden, equipment cost) as well as excellent adhesion performance and heat resistance performance without the use of an organic solvent, and a method of producing the same.

Further, the present invention relates to a new mixed aqueous dispersion of polyimide-fluororesin-polar crystal particulates and a method of producing the same, that can form a coating film or a coating having high-performance attachment and adhesion functions substantially exceeding conventional products and, in addition, being provided with excellent heat resistance, insulation, heat radiation dissipation property, and rust and corrosion resistance by the coexistence of polar crystal particulates in a mixed aqueous dispersion of polyimide-fluororesin-polar crystal particulates.

### Description of Related Art

Conventionally, mixtures of polyimide and fluororesin such as polytetrafluoroethylene (PTFE) have been known. These mixtures have a low coefficient of friction and are excellent in properties such as non-attachment, chemical resistance, and heat resistance; thus, they are widely used for surface treatment on articles for the food industry, kitchen utensils, such as frying pans and pots, articles for the household, such as irons, articles for the electric industry, articles for the machine industry, and the like.

For example, Japanese Unexamined Patent Application No. 2016-210886 discloses a composition of a polyimide precursor solution in which the dispersion state of the fluorine-based resin is uniformly controlled; polyimide and a polyimide film obtained from this composition, which are excellent in heat resistance, mechanical properties, electrical properties such as low dielectric constant and low dielectric loss tangent, and processability; a method of producing the same; and a circuit board and cover lay film of the polyimide film.

More particularly, Japanese Unexamined Patent Application No. 2016-210886 discloses a composition of a polyimide precursor solution containing fluorine-based resin, comprising at least: a non-water-based dispersion of fluorine-based resin comprising a micropowder of fluorine-based resin, and a fluorine-based additive containing at least a fluorine-containing group and a lipophilic group, wherein the amount of water measured by the Karl Fischer method is 5000 ppm or less; and a polyimide precursor solution.

Japanese Unexamined Patent Application No. 2016-210886 is to provide the composition of the polyimide precursor solution in which the dispersion state of the fluorine-based resin is uniformly controlled, the polyimide and the polyimide film obtained from this composition, which are excellent in heat resistance, mechanical properties, slidability, insulation, electrical properties such as low dielectric constant and low dielectric loss tangent, and processability, and the method of producing the same, as well as the circuit board, cover lay film, insulating film, interlayer insulating film for wiring substrates, surface protecting layer, sliding layer, peeling layer, fiber, filter material, wire coating material, bearing, coating, heat insulating shaft, trays, various belts such as a seamless belt, tape, tube, and the like of the polyimide or the polyimide film. However, the composition described in Japanese Unexamined Patent Application No. 2016-210886 comprises an organic solvent as a solvent to uniformly disperse the polyimide and the fluororesin, there has been a problem with handleability (e.g. safety, environmental burden, equipment cost). For this reason, there has been a need for a mixed aqueous dispersion of polyimide and fluororesin excellent in handleability without the use of an organic solvent.

The present inventors have attempted to develop a mixed water-based dispersion of polyimide-fluororesin with excellent adhesion performance and heat resistance performance even without the use of an organic solvent. As a result, the present inventors have accomplished, as such a dispersion, a mixed aqueous dispersion comprising polyimide, fluororesin, alumina, and potassium persulfate, in which the polyimide and the fluororesin are uniformly dispersed, and a mixed powder produced from this dispersion, as well as a method of producing the same. This dispersion is provided with excellent adhesion performance and heat resistance performance and has excellent coating property, and, in addition, has excellent handleability (e.g. safety, environmental burden, equipment cost), since this mixed aqueous dispersion of polyimide-fluororesin does not comprise an organic solvent (Japanese Unexamined Patent Application No. 2019-98015).

### SUMMARY OF THE INVENTION

### Technical Problem

The present inventors have established the technique of providing polyimide (PI) in an aqueous form in the above Japanese Unexamined Patent Application No. 2019-98015 (a mixture of polyimide-fluororesin and a method of producing the same, which have been successfully developed and granted a patent), resulting in the commercialization of the mixture of this PI and water-dispersed PTFE as a coating. However, while being sufficiently applicable as a regular coating, this mixture of polyimide-fluororesin still has non-attachment or non-adhesion property; and thus, in the sense that it does not exceed such range of property, it is significantly far from the present inventors' ideal, high-level attachment and adhesion, and, for this reason, this mixture of polyimide-fluororesin has not been satisfactory as the present inventors' ideal, high-performance coating exceeding the conventional art.

Thus, the inventors have reconsidered the material formulation from every angle and analyzed the results as well as conducted various experiments associated with attachment and adhesion for the purpose of improving attachment and adhesion properties of the “mixture of polyimide-fluororesin”.

In these experiments, as a result of the reconsideration of the mechanism of adhesion property, the present inventors have discovered that the utilization of electrical interaction is effective in adhering a mixture (adhesive) to metals, SUS, aluminum, steel, copper, and the like in a perfect bonding state. That is, the present inventors have thought of obtaining favorable adhesion performance by using raw materials that have a positive (+) voltage (positive ion) for all the metals that are to be adhered and by using a raw material that has a (−) voltage for the raw material (mixture) configured as a coating.

As such raw material that has a (−) voltage, the present inventors have selected black tourmaline, pink tourmaline, and Rokusyo Stones (Registered Trademark), which are minerals having a naturally occurring voltage, and attempted to prepare a new mixture of polyimide-fluororesin by formulating them in a dispersion comprising PI and PTFE after converting them to a powder having a particle diameter of 3 μm or less. As a result of conducting over about 100 experiments in total, changing the formulation ratio, finally the present inventors have successfully developed a coating having (−) and (+) voltages, a natural electrodeposition coating in which the PI, PTFE, and tourmaline having a (−) voltage are formulated together with A1 sol and potassium persulfate. The development of such coating was succeeded, to the best of the present inventors' knowledge, for the first time in the world. This coating achieved perfect adhesion and bond, substantially exceeding the level of conventional coatings in the evaluation after firing at 380° C.

### The Means for Solving the Problem

That is, the present inventors have found that more outstanding adhesion performance, heat resistance performance, insulation performance, and the like than conventional coating agents of a mixture in which polyimide and fluororesin are mixed, are achieved by using an aqueous dispersion comprising polyimide, fluororesin, and polar crystal particulates, and have completed the present invention.

The invention according to a first aspect relates to a composition comprising a polyimide precursor or polyimide, fluororesin, polar crystal particulates, and water.

The invention according to a second aspect relates to the composition of the first aspect, wherein the polar crystal particulates are one or more selected from the group consisting of pink tourmaline, black tourmaline, and Rokusyo Stone (Registered Trademark).

The invention according to a third aspect relates to the composition of the first or second aspect, wherein the polyimide precursor comprises polyamide acid, polyamide imide, or polyamic acid, or a mixture thereof.

The invention according to a fourth aspect relates to the composition of the first to third aspects, wherein the polar crystal particulates have a particle diameter of 3 μm or below.

The invention according to a fifth aspect relates to the composition of the first to fourth aspects, wherein the weight ratio of the polyimide precursor and polyimide to the fluororesin is 45/55 to 15/85.

In a preferable aspect, the upper limit to the above weight ratio of the polyimide precursor and polyimide to the fluororesin is 45/55, 40/60, 35/65, 30/70, 25/75, or 20/80, and the lower limit to the above weight ratio of the polyimide and polyamide acid to the fluororesin is 40/60, 35/65, 30/70, 25/75, 20/80, or 15/85.

The invention according to a sixth aspect relates to the composition of the first to fifth aspects, wherein the weight ratio of the sum of the polyimide precursor and polyimide as well as the fluororesin to the polar crystal particulates is 100/20 to 100/40.

In a preferable aspect, the upper limit to the above weight ratio of the sum of the polyimide precursor and polyimide as well as the fluororesin to the polar crystal particulates is any of 100/20, 100/22, 100/24, 100/26, 100/28, 100/30, 100/32, 100/34, 100/36, or 100/38, and the lower limit is any of 100/22, 100/24, 100/26, 100/28, 100/30, 100/32, 100/34, 100/36, 100/38 or 100/40.

The invention according to a seventh aspect relates to the composition of any one of the first to sixth aspects, further comprising one or more selected from the group consisting of alumina, potassium persulfate, and phosphoric acid.

The invention according to an eighth aspect relates to the composition of any one of the first to seventh aspects, characterized in that the above fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

The invention according to a nineth aspect relates to the composition of any one of the first to eighth aspects in the form of a mixed aqueous dispersion.

The invention according to a tenth aspect relates to a method of producing a mixed aqueous dispersion of polyimide-fluororesin-polar crystal particulates, comprising steps of obtaining polar crystal particulates having a particle diameter of 3 μm or less by grinding and sieving polar crystal particulates, preparing a dispersion 1 containing the above polar crystal particulates, preparing a dispersion 2 containing polyimide and polyamide acid, preparing a dispersion 3 containing fluororesin, and mixing all the above dispersions 1, 2, and 3.

The invention according to an eleventh aspect relates to the production method of the tenth aspect, further comprising steps of preparing an aqueous potassium persulfate solution by adding potassium persulfate to water, preparing a dispersion 4 containing alumina, and mixing all the above dispersions and the aqueous potassium persulfate solution.

The invention according to a twelfth aspect relates to the production method of the tenth or eleventh aspect, wherein the polar crystal particulates are one or more selected from the group consisting of pink tourmaline, black tourmaline, and Rokusyo Stone (Registered Trademark).

The invention according to a thirteenth aspect relates to the production method of any one of the tenth to twelfth aspects, characterized in that the above fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

The invention according to a fourteenth aspect relates to a coating method, comprising steps of: applying the composition of any one of the first to ninth aspects to a coating surface on a metal material; and carrying out a heat treatment on the above metal material at 350 to 400° C.

The invention according to a fifteenth aspect relates to the coating method of the fourteenth aspect, further comprising a step of carrying out a cold treatment on the above metal material at 0 to 40° C.

The invention according to a sixteenth aspect relates to the coating method of the fifteenth aspect, wherein the step of carrying out the cold treatment is performed by soaking the metal material into water.

The invention according to a seventeenth aspect relates to a composition used for coating, comprising: the composition of any one of the first to ninth aspects; and a colorant component.

### Effects of the Invention

In accordance with the invention according to the first aspect, the mixed aqueous dispersion can be provided in which the polyimide precursor or polyimide and the fluororesin are uniformly dispersed, since the invention comprises the polyimide precursor or polyimide, fluororesin, polar crystal particulates, and water.

Therefore, the mixed aqueous dispersion of polyimide-fluororesin-polar crystal particulates with excellent coating property can be made without the use of an organic solvent.

Further, the mixed aqueous dispersion of the polyimide precursor or polyimide-fluororesin-polar crystal particulates has excellent handleability (e.g. safety, environmental burden, equipment cost), since the invention does not comprise an organic solvent.

Furthermore, the mixed aqueous dispersion of the polyimide precursor or polyimide-fluororesin-polar crystal particulates can form a coating film or a coating having high-performance attachment and adhesion functions substantially exceeding conventional products and, in addition, being provided with excellent heat resistance, insulation, heat radiation dissipation property, and rust and corrosion resistance, since the invention comprises polar crystal particulates.

In accordance with the invention according to the second aspect, the mixed aqueous dispersion of polyimide-fluororesin-polar crystal particulates can be made to form a coating film or a coating having high-performance attachment and adhesion functions substantially exceeding conventional products and, in addition, being provided with excellent heat resistance, insulation, heat radiation dissipation property, and rust and corrosion resistance, since the polar crystal particulates are one or more selected from the group consisting of pink tourmaline, black tourmaline, and Rokusyo Stone (Registered Trademark).

In accordance with the invention according to the third aspect, the mixed aqueous dispersion of polyimide-fluororesin-polar crystal particulates with more excellent coatability can be made, since the polyimide precursor comprises polyamide acid, polyamide imide, polyamic acid, or a mixture thereof.

In accordance with the invention according to the fourth aspect, the mixed aqueous dispersion of polyimide-fluororesin-polar crystal particulates with more excellent coatability can be made, since the polar crystal particulates have a particle diameter of 3 μm or below.

In accordance with the invention according to the fifth aspect, the composition with excellent heat resistance performance, processability, and formability can be provided, since the weight ratio of the polyimide precursor and polyimide to the fluororesin is 45/55 to 15/85.

In accordance with the invention according to the sixth aspect, the composition with more excellent heat resistance performance, processability, and formability can be made, since the weight ratio of the sum of the polyimide precursor and polyimide as well as the fluororesin to the polar crystal particulates is 100/20 to 100/40.

In accordance with the invention according to the seventh aspect, the composition with excellent heat resistance performance, processability, and formability can be provided, since the invention further comprises one or more selected from the group consisting of alumina, potassium persulfate, and phosphoric acid.

In accordance with the invention according to the eighth aspect, the aqueous dispersion with more excellent processability and formability can be provided, since the above fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

In accordance with the invention according to the ninth aspect, the mixed aqueous dispersion of polyimide-fluororesin-polar crystal particulates with excellent coating property can be made without the use of an organic solvent, since the invention is in the form of the mixed aqueous dispersion.

In accordance with the invention according to the tenth aspect, the mixed aqueous dispersion of polyimide-fluororesin-polar crystal particulates can be produced which can enhance dispersibility in an aqueous solution not comprising an organic solvent, is more excellent in dispersibility, and has more excellent coating property, since the invention is the method of producing the mixed aqueous dispersion of polyimide-fluororesin-polar crystal particulates, comprising the steps of: obtaining the polar crystal particulates having a particle diameter of 3 μm or less by grinding and sieving the polar crystal particulates; preparing the dispersion 1 containing the above polar crystal particulates; preparing the dispersion 2 containing polyimide and polyamide acid; preparing the dispersion 3 containing fluororesin; and mixing all the above dispersions 1, 2, and 3.

Further, this method can form a coating film or a coating having high-performance attachment and adhesion functions substantially exceeding conventional products and, in addition, being provided with excellent heat resistance, insulation, heat radiation dissipation property, and rust and corrosion resistance.

In accordance with the invention according to the eleventh aspect, the mixed aqueous dispersion of polyimide-fluororesin-polar crystal particulates with more excellent coating property can be produced, since the invention further comprises the steps of preparing the aqueous potassium persulfate solution by adding the potassium persulfate to the water, preparing the dispersion 4 containing alumina, and mixing all the above dispersions and the aqueous potassium persulfate solution.

In accordance with the invention according to the twelfth aspect, the mixed aqueous dispersion of polyimide-fluororesin-polar crystal particulates with more excellent coatability can be made, since the polar crystal particulates are one or more selected from the group consisting of pink tourmaline, black tourmaline, and Rokusyo Stone (Registered Trademark).

In accordance with the invention according to the thirteenth aspect, the aqueous dispersion with more excellent processability and formability can be provided, since the above fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

In accordance with the invention according to the fourteenth aspect, the coating method can be provided which brings adhesion property exceeding conventional techniques, since the invention comprises the steps of applying the composition of any one of the first to ninth aspects to a coating surface, and carrying out the heat treatment at 350 to 400° C.

In accordance with the invention according to the fifteenth aspect, the coating method can be provided which brings adhesion property exceeding conventional techniques, since the invention further comprises the step of carrying out the cold treatment on the above metal material at 0 to 40° C.

In accordance with the invention according to the sixteenth aspect, the coating method can be provided which brings adhesion property exceeding conventional techniques, since the step of carrying out the cold treatment is performed by soaking the metal material into water.

In accordance with the invention according to the seventeenth aspect, the coating can be provided which brings adhesion property exceeding conventional techniques, since the invention is a composition used for coating, comprising the composition of any one of the first to ninth aspects, and the colorant component.

### BRIEF DESCRIPTION OF DRAWINGS

FIG. 1 is a figure showing results of a thermogravimetric reduction TG-DTA test on a coating film of a mixed aqueous dispersion of polyimide-fluororesin-polar crystal particulates according to the present invention. The coating film of the present invention, a regular PTFE membrane, and a PI film were each heated at 10° C./min, and the thermal reduction rates (TG %) were measured.

FIG. 2 is a photograph showing a result of a cross cut test on a coating film of a mixed aqueous dispersion of polyimide-fluororesin-polar crystal particulates according to the present invention.

FIG. 3 is a photograph showing a result of a cross cut test on a comparative example, a coating film of a mixed aqueous dispersion of polyimide-fluororesin.

FIG. 4 is a photograph showing a result of a tape peel test on a coating film of a mixed aqueous dispersion of polyimide-fluororesin-polar crystal particulates according to the present invention.

FIG. 5 is a photograph showing an example of a coated frying pan using a mixed aqueous dispersion of polyimide-fluororesin-polar crystal particulates according to the present invention.

FIG. 6 is a photograph showing another example of a coated frying pan using a mixed aqueous dispersion of polyimide-fluororesin-polar crystal particulates according to the present invention.

FIG. 7 is a photograph showing an example of a coated heat sink for electronic devices using a mixed aqueous dispersion of polyimide-fluororesin-polar crystal particulates according to the present invention.

### DESCRIPTION OF EMBODIMENTS

Suitable embodiments of the composition according to the present invention, comprising polyimide-fluororesin-polar crystal particulates and water are discussed below.

The water used in the aqueous dispersion of the present invention is ion exchange water. Electrical interaction between structural components is important in order for the mixed aqueous dispersion of the present invention to exhibit its functions. Therefore, in the present invention, ion exchange water is suitably used, and basically tap water is not used.

The above composition may be a mixed aqueous dispersion (hereinafter, referred to merely as a mixed aqueous dispersion). This mixed aqueous dispersion comprises a polyimide precursor or polyimide, fluororesin, polar crystal particulates, and water.

Polyamide acid is also referred to as amic acid, and is known as a precursor of polyimide widely used as a chemical material. In recent years, polyamide acid has been industrially obtained by the degradation of polyimide as a waste material, and this has newly been used as a raw material to synthesize polyimide (Japanese Patent No. 6402283, 6487501, and 6186171).

Polyimide (PI) is resin consisting of polymers having imide bonds in their molecular structures.

Polyimide can be synthesized by, for example, a general synthesis method as shown in the below formula. In this synthesis method, tetracarboxylic acid dianhydride and diamine are polymerized in equimolar amounts as raw materials to obtain polyamide acid, which is a precursor of polyimide.

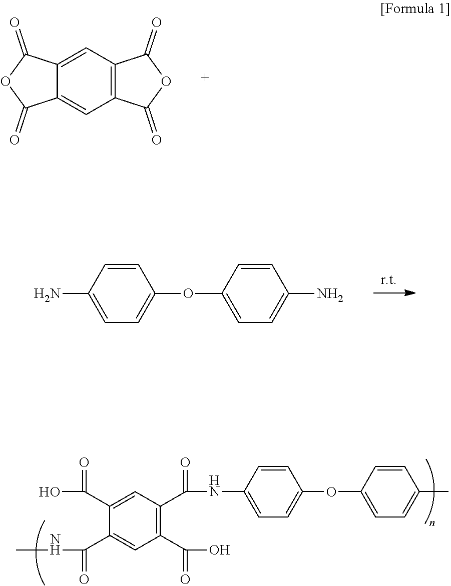

By heating this polyamide acid at 200° C. or higher or using a catalyst, dehydration and cyclization (imidization) reaction is proceeded, and polyimide is obtained. If a catalyst is used, usually an amine-based compound is used, and a carboxylic anhydride may be used together as a dehydrator to quickly remove water generated by the imidization.

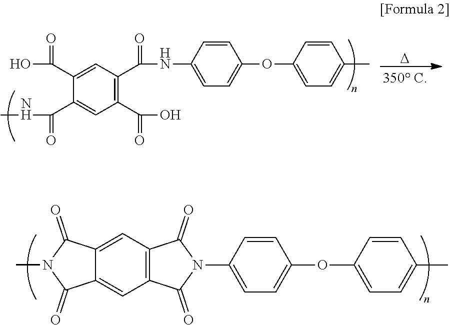

Herein, a polyimide precursor is a compound that may be a raw material of polyimide, and preferably indicates polyamide acid, polyamide imide, polyamic acid, or a mixture thereof. The polyimide precursor may comprise substances described in Japanese Patent No. 5695675 or Japanese Patent No. 6186171. The polyimide precursor is, for example, one shown below.

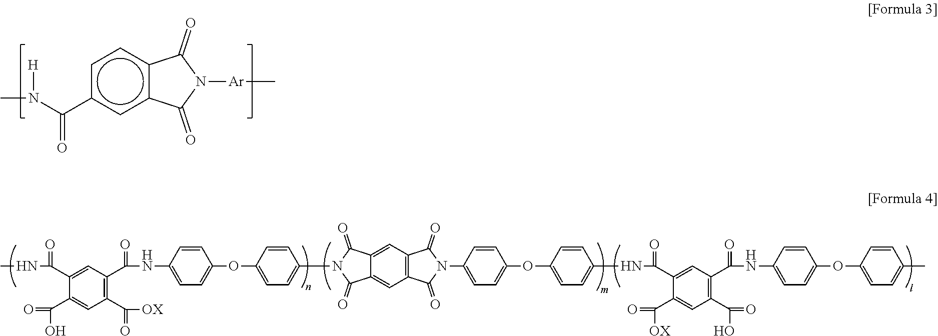

(Wherein the symbol X is an alkali metal (lithium/Li, sodium/Na, potassium/K, rubidium/Rb, or cesium/Ce), the subscripts n and l are symbols indicative of the abundances (numbers of moles) of the polyamide acid structures located on the sides of the polyimide structures and are regularly values in a range of 0.1 to 0.8, and the subscript m is a symbol indicative of the abundance (number of moles) of the polyimide structures and is regularly a value in a range of 0.2 to 0.9.)

The polyimide used for the mixed aqueous dispersion is not particularly limited; the polyimide includes, for example, a resin consisting of high molecular weight polymers obtained by the reaction of an aromatic tetravalent carboxylic anhydride such as pyromellitic dianhydride, or the like, and any can be used as long as it is obvious to a person skilled in the art.

Further, the polyimide used for the mixed aqueous dispersion may be one that used polyimide has been grinded and recycled, or it may be unused one.

The shape of the polyimide is not particularly limited, but the polyimide is in particulates and the size of the particles is preferably in a range of 1 μm to 100 μm from the point of view that they can be easily maintained in a suspended, dispersed state in the mixed aqueous dispersion for a long period of time.

The content of the polyimide is preferably 5% by weight to 40% by weight with respect to the mixed aqueous dispersion, and more preferably 10% by weight to 40% by weight, 15% by weight to 30% by weight, 10% by weight to 30% by weight, or 10% by weight to 20% by weight.

The mixed aqueous dispersion of the present invention preferably comprises polyamide acid, which is a precursor of polyimide. By heating the polyamide acid at 200° C. or higher, dehydration and cyclization (imidization) can be carried out. Through this imidization process, the polyamide acid-containing mixed aqueous dispersion can form a stronger coating.

Further, the mixed aqueous dispersion of the present invention may comprise polyimide analogs of one or more selected from polyamide acid or polyamide ester. These polyimide analogs bring positive effects to adhesion performance of the mixed aqueous dispersion and are essential components to create a highly heat-resistant and strong coating film. The mixed aqueous dispersion of the present invention preferably comprises a polyimide dispersion comprising polyamide acid.

The amount of the polyamide acid included in the aqueous dispersion of the present invention is 1 to 50% by weight, 5 to 40% by weight, or 10 to 30% by weight with respect to the total aqueous dispersion, and preferably 10 to 30% by weight. By including 10 to 30% by weight of the polyamide acid, an aqueous dispersion with more excellent coatability can be made.

As such, it should be understood that the term polyimide herein is used as polyimide in a broad sense to cover even a precursor of polyimide and polyimide analogs in addition to the polyimide included in the mixed aqueous dispersion.

The formulations preferably used in the present invention, which contain polyimide as a raw material, include, for example but not limited to, W-20 produced by NAKATA COATING CO., LTD.

Further, such formulations may comprise phosphoric acid, ethanol dispersion, amine, propylene glycol, nonionic component (neutral additive), carbon black as a colorant component, and the like.

The polar crystal herein refers to a crystal having a positive electrode (+) on one side and a negative electrode (−) on the opposite side. The polar crystal generates an unstable state (potential difference) at all times, and due to this potential difference, electrons are continuously emitted, flowing from the negative electrode toward the positive electrode. The polar crystal particulates herein refer to one or more selected from the group consisting of pink tourmaline, black tourmaline, and Rokusyo Stone (Registered Trademark) and suitably used, but not limited thereto.

Among the polar crystals, particularly well-known is tourmaline. Tourmaline refers to crystals of the chemical formula XY₃Al₆(BO₃)₃SiO₁₈(O,OH,F)₄, and among such crystals, dravite NaMg₃Al₆(BO₃)₃Si₆O₁₈(OH)₄, elbaite Na(Li,Al)₃Al₆(BO₃)₃Si₆O₁₈(OH)₄, schorl NaFe₃Al₆(BO₃)₃Si₆O₁₈(OH)₄, and uvite CaMg₃(Al₅Mg)(BO₃)₃Si₆O₁₈(OH,F)₄ are so-called tourmaline.

It is said that tourmaline was excavated in the island of Ceylon, current Sri Lanka, in 1703 and brought to Europe. Later, in 1880, Pierre Curie, who received the Nobel Prize in Physics, found that an electric charge is generated on the crystal's surface upon the appliance of external pressure to the tourmaline. Further, it was revealed that an electric charge is also generated upon the addition of heat energy to the tourmaline. The phenomenon caused upon the addition of pressure to the tourmaline is called pressure-electricity (piezo electricity), and the phenomenon in which, upon the addition of heat, electrons are separated to both poles of the crystal and positive and negative charges are generated is called pyroelectricity. When pressure or heat is added to the tourmaline, positive and negative electrodes are generated in both electrodes of the stone and electricity is generated. The positive electrode attracts electrons and emits the electrons from the negative electrode to the outside of the crystal (where the electricity flows easily, such as the inside of water or the skin surface of the body). The generated water or moisture in the air is electrolyzed to emit hydroxyl ions (H³O²⁻), negative ions.

In the present invention, a coating agent or a coating with outstanding coating property can be obtained by using the polar crystals; however, this is presumed to be due to, but not limited to, electrical properties such as the above properties of tourmaline. The polar crystal of the present invention can be made by grinding a polar crystal mineral to particulates (e.g. particle diameter of 10 μm or less, 5 μm or less, or 1 μm or less), and this can be used as a aqueous dispersion. The aqueous dispersion of polar crystal is, for example, a suspension having a concentration of 5% by weight to 40% by weight.

As the polar crystal, Rokusyo Stone (Registered Trademark) may be used. Rokusyo Stone (Registered Trademark) is a tuffaceous basalt rock, which consists of strip-like plagioclase; clinopyroxene, opaque minerals, and a small amount of olivine filled therebetween; and spherical or amorphous ceradonite, and it is a so-called mineral distributed around in the surrounding rocks of an amethyst. With regard to the components, the one comprising 5% or more by weight of Fe₂O₃ is preferable, and the one comprising 7% or more is particularly preferable.

Further, as the polar crystal of the present invention, substances with a piezoelectric effect can be used. Such substances comprise ones known as raw materials of a piezoelectric element or a piezoelectric body. Specifically, they comprise natural and synthetic crystals, and ceramic materials of barium titanate (BaTiO₃), lead zirconate titanate (PZT), zinc oxide (ZnO), lithium niobate (LiNbO₃), lithium tantalate (LiTaO₃), and the like. Among such ceramic materials, the PZT piezoelectric ceramic material exists in multiple variations, and, by doping the PZT ceramic with ions such as nickel, bismuth, lanthanum, neodymium, and niobium, the piezoelectric parameters and dielectric parameters can be optimized.

The fluororesin used for the mixed aqueous dispersion is not particularly limited, but includes, for example, resin particulates consisting of polymers or copolymers of monomers selected from tetrafluoroethylene, hexafluoropropylene, chlorotrifluoroethylene, perfluoro(alkyl vinyl ether), vinylidene fluoride, and vinyl fluoride.

Among these, ones that can be dispersed in water are used for the preparation of the mixed aqueous dispersion.

The shape of the fluororesin is not particularly limited, but is preferably in particulates, having an average molecular weight in a range of 1×10⁴ to 1×10⁷ and a particle size in a range of 100 to 500 nm from the point of view that it can be easily maintained in a suspended, dispersed state in the mixed aqueous dispersion for a long period of time.

The content of the fluororesin (content of fluororesin solid content) is preferably 20% by weight to 60% by weight with respect to the mixed aqueous dispersion, and more preferably 35% by weight to 45% by weight.

As above, the fluororesin used for the mixed aqueous dispersion is not particularly limited, but A-1: Polyflon D-111 produced by DAIKIN INDUSTRIES, LTD., (PTFE solid content: 55 to 65% by weight, average molecular weight: 2×10⁴ to 1×10⁷, particle size: 0.25 μm, pH: 9.7), A-2: AD911E produced by ASAHI GLASS CO., LTD. (PTFE solid content: 60% by weight, average molecular weight: 2×10⁴ to 1×10⁷, particle size: 0.25 μm, pH: 10), A-3: 31-JR produced by MITSUI FLUORO CO., LTD. (PTFE solid content: 60% by weight, average molecular weight: 2×10⁴ to 1×10⁷, particle size: 0.25 μm, pH: 10.5), or the like can be used. The particle size refers to the average particle diameter of PTFE primary particles.

Further, the fluororesin used for the mixed aqueous dispersion may be a PTFE dispersion, and this PTFE dispersion may comprise a neutral surfactant, nonionic surfactant, amine, glycol, and the like. As such dispersion, PTFE-D (produced by DAIKIN INDUSTRIES, LTD.,) or the like is preferably used.

The mixed aqueous dispersion may comprise alumina. The alumina in the present invention covers aluminum oxide particulates of aluminum oxide [composition formula: Al₂O₃], amorphous aluminum hydroxide, gibbsite, and bialite [composition formula: Al(OH)₃], and/or boehmite and diaspore [composition formula: AlOOH].

The alumina preferably has a particulate particle size in a range of 5 to 4500 nm from the point of view that they can be easily maintained in a suspended, dispersed state in the mixed aqueous dispersion for a long period of time.

The content of the alumina is preferably 1% by weight to 10% by weight with respect to the mixed aqueous dispersion, more preferably 3% by weight to 7% by weight. This is because when the content of the alumina is less than 1% by weight, sufficient alumina-induced adhesion performance and heat resistance performance cannot be given to the mixed aqueous dispersion and when the content of the alumina is over 10% by weight, further effects cannot be expected to be given.

The mixed aqueous dispersion with excellent adhesion performance and heat resistance performance can be made by containing the alumina in the mixed aqueous dispersion.

Further, the shape of the alumina of the alumina sol is not particularly limited, and may be in any shape, such as a tabular, columnar, fiber, or hexagonal tabular shape.

If the alumina sol has a fiber shape, the alumina is an alumina crystal in a fiber shape. More specifically, the alumina includes an alumina fiber formed of alumina anhydrate, an alumina hydrate fiber formed of an alumina comprising a hydrate, and the like.

The alumina used for the mixed aqueous dispersion is not particularly limited, but includes, for example, Alumina Sol-10A (% by weight in terms of Al₂O₃: 9.8 to 10.2, particle size (nm): 5 to 15, viscosity: 25° C., mPa/s: <50, pH: 3.4 to 4.2, produced by KAWAKEN FINE CHEMICALS CO., LTD.), Alumina Sol-A2 (% by weight in terms of Al₂O₃: 9.8 to 10.2, particle size (nm): 10 to 20, viscosity: 25° C., mPa/s: <200, pH: 3.4 to 4.2, produced by KAWAKEN FINE CHEMICALS CO., LTD.), Alumina Sol-CSA-110AD (% by weight in terms of Al₂O₃: 6.0 to 6.4, particle size (nm): 5 to 15, viscosity: 25° C., mPa/s: <50, pH: 3.8 to 4.5, produced by KAWAKEN FINE CHEMICALS CO., LTD.), Alumina Sol-F1000 (% by weight in terms of Al₂O₃: 4.8 to 5.2, particle size (nm): 1400, viscosity: 25° C., mPa/s: <1000, pH: 2.9 to 3.3, produced by KAWAKEN FINE CHEMICALS CO., LTD.), Alumina Sol-F3000 (% by weight in terms of Al₂O₃: 4.8 to 5.2, particle size (nm): 2000 to 4500, viscosity: 25° C., mPa/s: <1000, pH: 2.7 to 3.3, produced by KAWAKEN FINE CHEMICALS CO., LTD.), and the like, and any can be used as long as it is alumina sol obvious to a person skilled in the art.

As above, the alumina used for the mixed aqueous dispersion is not particularly limited, but alumina particulates having hydroxyl groups (OH groups) are preferably used.

By using alumina having OH groups, the chemical bond strength (adhesion strength) due to the OH groups of the alumina increases, and thus, the mixed aqueous dispersion can be given more excellent adhesion performance.

Further, other metal oxide particulates may be added instead of the alumina, or in addition of the alumina.

As the other metal oxide particulates, titanium oxide, zirconium oxide, lanthanum oxide, neodymium oxide, cerium oxide, tin oxide, and the like can be used, but are not particularly limited thereto.

By adding other metal oxide particulates instead of the alumina, or in addition of the alumina, mixed aqueous dispersions of polyimide-fluororesin-polar crystal particulates that has a different coating property from the one produced when only the alumina is added can be produced.

The mixed aqueous dispersion comprises potassium persulfate. Since potassium persulfate is a compound containing an OH group, the number of OH groups included in the mixed aqueous dispersion can be increased and the chemical bond strength (adhesion strength) due to the OH groups will be increased, and thus, the mixed aqueous dispersion can be given excellent adhesion.

The content of the potassium persulfate is preferably 0.1% by weight to 5% by weight with respect to the mixed aqueous dispersion, more preferably 1% by weight to 3% by weight. This is because when the content of the potassium persulfate is less than 0.1% by weight, sufficient potassium persulfate-induced adhesion performance cannot be given to the mixed aqueous dispersion, and when the content of the potassium persulfate is over 5% by weight, further effects cannot be expected to be given.

Further, other compounds containing OH groups may be added instead of the potassium persulfate, or in addition of the potassium persulfate.

As the other compounds containing OH groups, acetic acid, benzoic acid, phenylphosphonic acid, a benzoyl compound, and the like may be used, but are not particularly limited thereto.

The mixed aqueous dispersion may further comprise polyvinyl alcohol (PVA).

The PVA has a structural formula shown below and contains a number of OH groups.

Therefore, the number of OH groups included in the mixed aqueous dispersion can be increased and the chemical bond strength (adhesion strength) due to the OH groups will be increased, and thus, the mixed aqueous dispersion can be given excellent adhesion.

Further, the PVA remains stably in the mixed aqueous dispersion even after being formulated in the mixed aqueous dispersion, and the adhesion is less likely to reduce.

Therefore, excellent adhesion of the mixed aqueous dispersion can be maintained stably over a long period of time.

The content of the PVA is preferably 0.5% by weight to 10% by weight with respect to the mixed aqueous dispersion, more preferably 3% by weight to 6% by weight. This is because when the content of the PVA is less than 0.5% by weight, sufficient PVA-induced adhesion performance cannot be given to the mixed aqueous dispersion, and when the content of the PVA is over 10% by weight, further effects cannot be expected to be given.

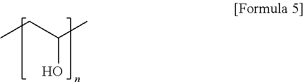

The mixed aqueous dispersion may further comprise phosphoric acid.

Since phosphoric acid is a compound containing an OH group, the number of OH groups included in the mixed aqueous dispersion can be increased and the chemical bond strength (adhesion strength) due to the OH groups will increase, and thus, the mixed aqueous dispersion can be given excellent adhesion.

The content of the phosphoric acid is preferably 0.1% by weight to 5% by weight with respect to the mixed aqueous dispersion, more preferably 1% by weight to 3% by weight. This is because when the content of the phosphoric acid is less than 0.1% by weight, sufficient phosphoric acid-induced adhesion performance cannot be given to the mixed aqueous dispersion, and when the content of the phosphoric acid is over 5% by weight, further effects cannot be expected to be given.

The phosphoric acid may be used for pretreatment of the polyimide used for the mixed aqueous dispersion.

The polyimide is added to and mixed with a phosphoethanol containing phosphoric acid and then the ethanol is vaporized, so that mixed powder of polyimide-phosphoric acid can be obtained.

The mixed powder of polyimide-phosphoric acid can be more easily dispersed by a water-based solvent, compared to polyimide alone.

The mixed aqueous dispersion may contain different additives or the like other than the above elements, to reform the mixed aqueous dispersion.

The additives include, for example but not limited to, solvents, tackifiers, plasticizer, hardener, vernetzer, diluents, fillers, thickeners, pigments, and the like, and any can be used as long as it is regularly used to reform the property of the mixed aqueous dispersion and is obvious to a person skilled in the art.

The mixed aqueous dispersion of polyimide-fluororesin-polar crystal particulates may comprise, optionally, colorants such as carbon black. It is important that this mixed aqueous dispersion has a pH maintained in the neutral range of 7.0 to 8.0. If this mixed aqueous dispersion has a pH on the acid side (e.g. pH 6.0), heat shock may occur upon the formation of a coating film, which may result in the occurrence of cracks in the coating film or the occurrence of solid contents.

A method of producing the mixed aqueous dispersion of a polyimide precursor or polyimide-fluororesin-polar crystal particulates is discussed below.

This method of producing the mixed aqueous dispersion comprises steps of: obtaining polar crystal particulates having a particle diameter of 3 μm or less by grinding and sieving polar crystal particulates; preparing a dispersion 1 containing the above polar crystal particulates; preparing a dispersion 2 containing a polyimide precursor or polyimide; preparing a dispersion 3 containing fluororesin; and mixing all the above dispersions 1, 2, and 3.

This method of producing the mixed aqueous dispersion may further comprise steps of: preparing an aqueous potassium persulfate solution by adding potassium persulfate to water; preparing a dispersion 4 containing alumina; and mixing all the above dispersions and the aqueous potassium persulfate solution.

In another aspect, the method of producing this mixed aqueous dispersion comprises steps of: preparing an aqueous potassium persulfate solution by adding potassium persulfate to water; and mixing polyimide, fluororesin, polar crystal particulates, alumina, and the above aqueous potassium persulfate solution.

Further, the method of producing the mixed aqueous dispersion may comprise, as the step of pretreatment, a step of prepare mixed powder of polyimide-phosphoric acid by mixing the polyimide with a phosphoric acid ethanol solution and then drying it.

The mixing method, the mixing temperature, and the mixing time in these steps are not particularly limited, and any can be used as long as it is a mixing method that can produce a mixed aqueous dispersion and has been used conventionally.

The aqueous potassium persulfate solution is prepared by adding solid potassium persulfate to water.

More specifically, the aqueous potassium persulfate solution is prepared by adding potassium persulfate to water so that the amount of the potassium persulfate becomes 1% by weight and heating it to the extent that the water will not boil, to dissolve the potassium persulfate.

In some cases, difficulty arises in dissolving the polyimide in a water-based solvent. Thus, to improve the water dispersibility of the polyimide, the polyimide can be pretreated before formulation of the mixed aqueous dispersion.

The step of pretreatment comprises producing mixed powder of polyimide-phosphoric acid by mixing the polyimide with a phosphoric acid ethanol solution and then drying the mixed solution to evaporate water.

By using the mixed powder of polyimide-phosphoric acid, the polyimide can have greatly improved water dispersibility compared to when the polyimide is used alone, and thus the mixed aqueous dispersion according to the present invention can be more easily produced.

It is needless to say that the mixed aqueous dispersion according to the present invention can be produced without execution of this step of pretreatment.

The prepared mixed aqueous dispersion can be converted to mixed powder of polyimide-fluororesin by evaporation of water.

The mixed powder of polyimide-fluororesin can be used as an excellent molding material that can be used for a wide range of products such as highly heat-resistant products, since it comprises polyimide and fluororesin uniformly mixed and also it comprises alumina and potassium persulfate that give excellent adhesion and heat resistance.

The mixed powder of polyimide-fluororesin can be produced by drying the mixed aqueous dispersion of polyimide-fluororesin-polar crystal particulates according to the present invention and evaporating water.

The drying method to produce the mixed powder of polyimide-fluororesin is not particularly limited, and any method may be used as long as it is a method that can evaporate water in the mixed aqueous dispersion of polyimide-fluororesin-polar crystal particulates according to the present invention and convert it to powder.

The coating method of the present invention, using the mixed aqueous dispersion of the polyimide precursor or polyimide-fluororesin-polar crystal particulates, comprises steps of applying the above mixed aqueous dispersion of the polyimide precursor or polyimide-fluororesin-polar crystal particulates to a coating surface, and carrying out a heat treatment at 350 to 400° C.

The heat treatment is also referred to as firing, and it is a step required for the generation of the coating of the present invention; however, the method of the heat treatment is not particularly limited, and a regular heater used in the subject field can be used. The step of carrying out the heat treatment is considered to be an essential step for the strengthening of the coating surface. The step of carrying out the heat treatment may be referred to as “heat shock” herein.

Further, the coating method of the present invention, using the mixed aqueous dispersion of the polyimide precursor or polyimide-fluororesin-polar crystal particulates, further comprises the step of carrying out a cold treatment on the above metal material at 0 to 40° C. The method of the cold treatment is not particularly limited, a regular cooling method used in the subject field can be used. The cooling method include, as specific examples, soaking the metal material having the coating surface into water. The cold treatment is carried out at any temperature between 0 to 40° C.; for example, the lower limit to the temperature of the cold treatment includes 0° C., 5° C., 10° C., 15° C., 20° C., 25° C., and 30° C., and the upper limit to the temperature of the cold treatment includes 20° C., 25° C., 30° C., 35° C., and 40° C. The step of carrying out the cold treatment is also referred to as a quenching step, and it is considered to be an essential step for the strengthening of the coating surface. The cold treatment may be referred to as “cold shock” herein.

### EXAMPLE

The present invention is discussed in more detail below, using an example, but the present invention is not limited to such example.

### <Cross Cut Test>

The performance as a coating agent of the aqueous dispersion according to the present invention is examined by means of cross cut tests.

The configurations and the production methods of an example and a comparative example are as below.

### EXAMPLE

The composition of the example is as below.

Polyimide dispersion (W-20; produced by NAKATA COATING CO., LTD.): 30% by weight
PTFE dispersion (PTFE-D; produced by DAIKIN INDUSTRIES, LTD.,): 70% by weight Alumina sol (A1-L7; produced by TAKI CHEMICAL CO., LTD.): 5% by weight Potassium persulfate: 1% by weight
Pink tourmaline dispersion: pink tourmaline having a particle diameter of 3 μm or below (originated from Sri Lanka) was prepared as a 30%, 10% and 5% dispersion.

The example was prepared as below.

1. The pink tourmaline powder was converted into a 5% suspension by carrying out a grinding process by a standard method, passing it through a 3 μm sieve to separate particulates having a particle diameter of 3 μm or below, and adding water.
2. An aqueous potassium persulfate solution was prepared by adding the potassium persulfate to pure water such that the potassium persulfate became 1% by weight, and heating at 95° C. to dissolve the potassium persulfate.
3. The polyimide dispersion, the PTFE dispersion, the alumina sol, the aqueous potassium persulfate solution, and the pink tourmaline dispersion were mixed, to thereby produce the example (mixed aqueous dispersion of polyimide-fluororesin-polar crystal particulates). At this moment, the PH was confirmed to be 7.0 to 8.0.

### COMPARATIVE EXAMPLES

The composition of the comparative example is as below.

Polyimide dispersion (W-20; produced by NAKATA COATING CO., LTD.): 30% by weight
PTFE dispersion (PTFE-D; produced by DAIKIN INDUSTRIES, LTD.,): 70% by weight
Alumina sol (A1-L7; produced by TAKI CHEMICAL CO., LTD.): 5% by weight
Potassium persulfate: 1% by weight

The comparative example was prepared as below.

1. An aqueous potassium persulfate solution was prepared by adding the potassium persulfate to pure water such that the potassium persulfate became 1% by weight, and heating at 95° C. to dissolve the potassium persulfate.
2. The polyimide dispersion, the PTFE dispersion, the alumina sol, and the aqueous potassium persulfate solution were mixed, to thereby produce the comparative example (mixed aqueous dispersion of polyimide-fluororesin-polar crystal particulates). At this moment, the PH was confirmed to be 7.0 to 8.0.

### (Performance Evaluation Test 1—Cross Cut Test)

### (Test Method)

Cross cut tests were conducted as below.

1. The compositions of the example and the comparative example were each stirred with a constant-temperature shaker at 60° C. for 2 hours.
2. By coating the stirred compositions of the example and the comparative example on aluminum plates having a thickness of 2 mm (each n=2), using a bar coater, samples were prepared.
3. The samples were fired at 380° C. for 15 to 20 minutes.
4. The fired samples were cooled in tap water at room temperature (25° C.).
5. Cross cut tests (cross cut method) specified in JIS K5600 5-6 were conducted, using the fired and cooled samples.

### (Test Results)

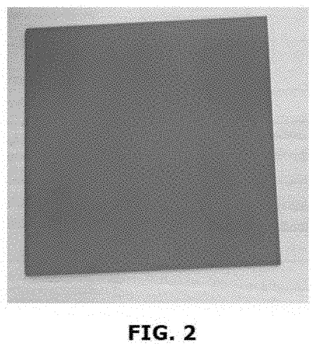

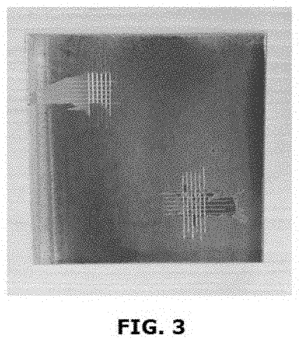

The results of the cross cut tests are shown in FIGS. 2-3.

FIG. 2 is a figure showing the result of the cross cut test using the mixed aqueous dispersion of polyimide-fluororesin-polar crystal particulates (example) according to the present invention. FIG. 3 is a figure showing the result of the cross cut test using the mixed aqueous dispersion of polyimide-fluororesin-polar crystal particulates of the comparative example.

As shown in FIG. 2, it was discovered that the example coated on the aluminum plate had perfect adhesion at the highest level as the applicability of the coating was favorable and no peel of the coating film was found at all.

In contrast, as shown in FIG. 3, the comparative example coated on the aluminum plate remained to have a conventional level of adhesion although the applicability of the coating was favorable and few peels of the coating film were found.

Based on the result of the cross cut tests, the comparative example comprising the polyimide, the PTFE, the alumina sol, and the potassium persulfate, and not comprising the pink tourmaline remained to have standard adhesion performance.

In contrast, the example comprising the pink tourmaline in addition to the polyimide, the PTFE, the alumina sol, and the potassium persulfate, showed unprecedented strong adhesion performance.

This is assumed to be due to the electrostatic interaction between negative ions emitted from the tourmaline upon heating and the metal surface of the base material, which increased adhesion performance of the coating (coating film). (Performance Evaluation Test 2—Peel Test with Fabric Tape (Tape Peel Test))

### (Tape Peel Test)

A tape peel test was conducted as below.

1. The compositions of the example and the comparative example were each stirred with a constant-temperature shaker at 60° C. for 2 hours.
2. Fabric tape (1 cm×10 cm) was taped along the entire length of an aluminum plate having a size of 50 mm×100 mm×2 mm (each n=2). The entire length of the fabric tape was longer than the entire length of the aluminum plate. The aluminum plate was used as a test piece. On up to the upper half of the fabric tape in the length direction of the test piece, the stirred example and comparative example were coated, using a bar coater.
3. The coating surface of the test piece was fired at 380° C. for 15 to 20 minutes.
4. The fired test piece was cooled in tap water at room temperature (25° C.).
5. The PTFE dispersion (60% solid content and 40% water) was applied to the entire test piece (35 μm to 60 μm in thickness) as a top coat, and was dried.
6. In the dried test piece, the fabric tape was peeled off by pulling the tape upwardly from the side to which only the top coat had been applied, and the degree of peeling of the fabric tape from the border between the part to which only the top coat had been applied and the part to which the example or the comparative example had been applied was evaluated.

### (Test Results)

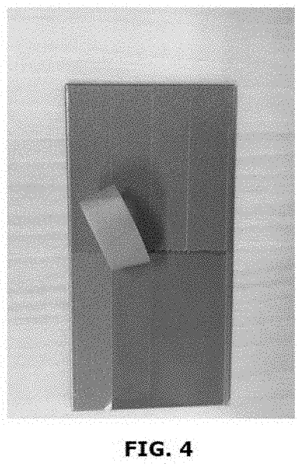

The result of the tape peel test is shown in FIG. 4.

The upper part of FIG. 4 is a figure showing the result of the tape peel test using the mixed aqueous dispersion of polyimide-fluororesin-polar crystal particulates (the example) according to the present invention. The lower part of FIG. 4 is a figure showing the result of the tape peel test using the mixed aqueous dispersion of polyimide-fluororesin-polar crystal particulates of the comparative example.

As shown in FIG. 4, it was discovered that the example coated on the aluminum plate had perfect adhesion at the highest level as no peel of the coating film was found at all regardless of the force of pulling of the fabric tape.

In contrast, the comparative example coated on the aluminum plate had strong adhesion of the coating film, but to the extent in which peel occurs when pulled with a force (Data not shown).

Based on the result of the tape peel test, the comparative example comprising the polyimide, the PTFE, the alumina sol, and the potassium persulfate, and not comprising the pink tourmaline remained to have standard adhesion performance.

In contrast, the example comprising the pink tourmaline in addition to the polyimide, the PTFE, the alumina sol, and the potassium persulfate, showed unprecedented strong adhesion performance.

This is assumed to be due to the electrostatic interaction between negative ions emitted from the tourmaline upon heating and the metal surface of the base material, which increased adhesion performance of the coating (coating film).

### (Heat Resistance)

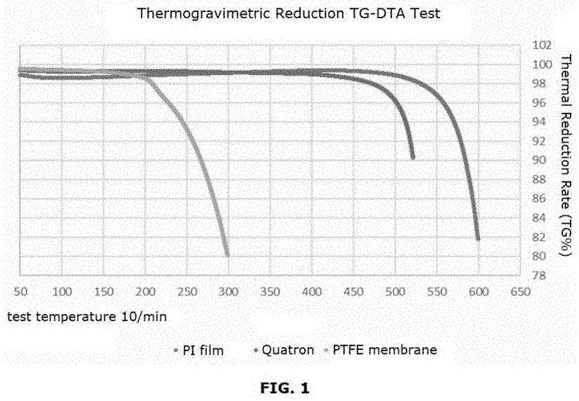

A thermogravimetric reduction TG-DTA test on a coating film that uses the mixed aqueous dispersion of polyimide-fluororesin-polar crystal particulates according to the present invention was performed, and the coating film of the present invention, a regular PTFE membrane, and a PI film were each heated at 10° C./min, and the thermal reduction rates (TG %) were measured. The result was shown in FIG. 1. It was revealed that the coating film of the present invention has heat resistance of about 450° C.

### Application Example 1—Coating on Frying Pan

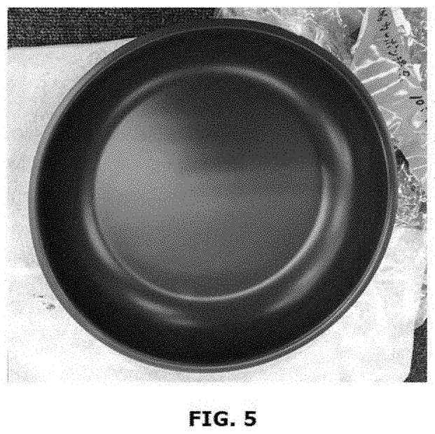

The mixed aqueous dispersion of polyimide-fluororesin-polar crystal particulates of the example was applied on the surface of a household frying pan as a coating agent. A 30% dispersion of the pink tourmaline was used. The coating had a thickness of 40 μm (Application Example 1-1 with a photo shown in FIG. 5).

The frying pan in Application Example 1-1 showed heat resistance and durability exceeding conventional Teflon (Registered Trademark) coated frying pans.

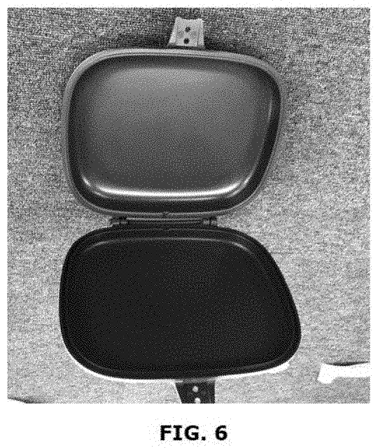

Further, another household frying pan was obtained and the mixed aqueous dispersion of polyimide-fluororesin-polar crystal particulates was applied thereon as a coating agent in the same manner. The coating had a thickness of 40 μm (Application Example 1-2 with a photo shown in FIG. 6).

The frying pan in Application Example 1-2 also showed heat resistance and durability exceeding conventional Teflon (Registered Trademark) coated frying pans, and the reproducibility of the effect obtained from this coating agent was confirmed.

### Application Example 2—Coating on Heat Sink for Electronic Devices

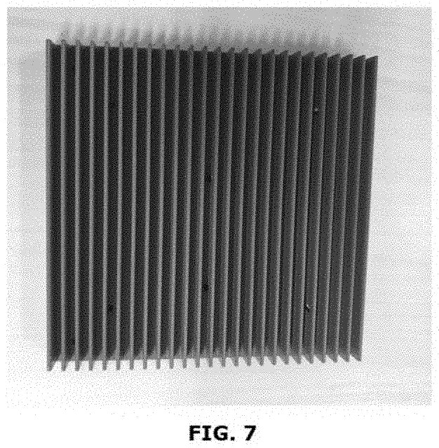

The mixed aqueous dispersion of polyimide-fluororesin-polar crystal particulates of the example was applied on a general heat sink for computer components as a coating agent. The coating had a thickness of 40 μm. The photo of this heat sink is shown in FIG. 7.

The heat sink in Application Example 2 showed excellent heat radiation dissipation function and excellent insulation in addition to heat resistance and durability, and exhibited sufficient performance as a heat sink.

### INDUSTRIAL APPLICABILITY

In accordance with the mixed aqueous dispersion of polyimide-fluororesin-polar crystal particulates according to the present invention, the mixed aqueous dispersion in which polyimide and fluororesin are uniformly dispersed can be provided, since the mixed aqueous dispersion of polyimide-fluororesin-polar crystal particulates comprises polyimide, fluororesin, and polar crystal particulates.

Further, the mixed aqueous dispersion which exhibits adhesion performance and heat resistance performance exceeding conventional products can be provided, since the mixed aqueous dispersion of polyimide-fluororesin-polar crystal particulates of the present invention comprises polar crystal particulates.

Therefore, the mixed aqueous dispersion of polyimide-fluororesin-polar crystal particulates with exceptional coating property can be made without the use of an organic solvent.

Further, the mixed aqueous dispersion of polyimide-fluororesin-polar crystal particulates has excellent handleability (e.g. safety, environmental burden, equipment cost), since it does not comprise an organic solvent.

Therefore, the mixed aqueous dispersion of polyimide-fluororesin-polar crystal particulates according to the present invention is suitably used as a heat resistant coating for pods, kettles, frying pans, and the like, a heat resistant impregnant for knitted fabrics, woven fabrics, glass fabric materials, carbon fibers, carbonized fibers, and the like, and a coating agent and a coating for other various products.

Further, In accordance with the mixed aqueous dispersion of polyimide-fluororesin-polar crystal particulates according to the present invention, a molding material can be provided in which polyimide and fluororesin are uniformly dispersed and which can be used for a wide range of products such as highly heat-resistant products, since the mixed powder of polyimide-fluororesin comprises polyimide, fluororesin, alumina, and potassium persulfate.

The mixed powder with excellent heat resistance performance, processability, and moldability can be made, since the mixed aqueous dispersion of polyimide-fluororesin-polar crystal particulates comprises alumina and potassium persulfate.

Therefore, the mixed aqueous dispersion of polyimide-fluororesin-polar crystal particulates according to the present invention is suitably used as a mold powder for bearings, friction materials, sliding bearings, corrosion resistant materials, insulation material, and the like, and other various products.

Further, the mixed aqueous dispersion of polyimide-fluororesin-polar crystal particulates according to the present invention can be broadly used for components, exteriors, and the like of electrical products such as mobile phones and smart phones, since the mixed aqueous dispersion achieves excellent insulation performance.

1. A composition, comprising: a polyimide precursor or polyimide; fluororesin; polar crystal particulates; and water.

2. The composition of claim 1, wherein the polar crystal particulates are particles of one or more selected from the group consisting of pink tourmaline, black tourmaline, and Rokusyo Stone (Registered Trademark).

3. The composition of claim 1, wherein the polyimide precursor comprises polyamide acid, polyamide imide, polyamic acid, or a mixture thereof.

4. The composition of claim 1, wherein the polar crystal particulates have a particle diameter of 3 μm or below.

5. The composition of claim 1, wherein a weight ratio of the polyimide precursor and polyimide to the fluororesin is 45/55 to 15/88.

6. The composition of claim 1, wherein a weight ratio of a sum of the polyimide precursor and polyimide as well as the fluororesin to the polar crystal particulates is 100/20 to 100/40.

7. The composition of claim 1, further comprising one or more selected from the group consisting of alumina, potassium persulfate, and phosphoric acid.

8. The composition of claim 1, wherein the fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

9. The composition of claim 1, wherein the composition is in a form of a mixed aqueous dispersion.

10. A method of producing a mixed aqueous dispersion of a polyimide precursor or polyimide-fluororesin-polar crystal particulates, comprising steps of:
obtaining polar crystal particulates having a particle diameter of 3 μm or less by grinding and sieving polar crystal particulates;
preparing a dispersion 1 containing the polar crystal particulates;
preparing a dispersion 2 containing a polyimide precursor or polyimide;
preparing a dispersion 3 containing fluororesin; and
mixing all the dispersions 1, 2, and 3.

11. The production method of claim 10, further comprising steps of:
preparing an aqueous potassium persulfate solution by adding potassium persulfate to water;
preparing a dispersion 4 containing alumina; and
mixing all the dispersions and the aqueous potassium persulfate solution.

12. The production method of claim 10, wherein the polar crystal particulates are one or more selected from the group consisting of pink tourmaline, black tourmaline, and Rokusyo Stone (Registered Trademark).

13. The production method of claim 10, characterized in that the fluororesin is fluororesin particulates consisting of polymers or copolymers of monomers selected from the group consisting of tetrafluoroethylene, hexafluoropropylene, chlorotrifluoroethylene, perfluoro(alkyl vinyl ether), vinylidene fluoride, and vinyl fluoride.

14. A coating method, comprising steps of:
applying the composition of claim 1 to a coating surface on a metal material; and
carrying out a heat treatment on the metal material at 350 to 400° C.

15. The coating method of claim 14, further comprising a step of carrying out a cold treatment on the metal material at 0 to 40° C.

16. The coating method of claim 14, wherein the step of carrying out the cold treatment is performed by soaking the metal material into water.

17. A composition used for coating, comprising: the composition of claim 1 and a colorant component.
